(19) United States
(12) Patent Application Publication
(10) Pub. No.: US 2008/0235719 A1
(43) Pub. Date: Sep. 25, 2008

(54) Image analysis for use with automated audio extraction

(76) Inventor: Yugal K. Sharma, Washington, DC (US)

Correspondence Address: Nields & Lemack, 176 E. Main Street, Suite #5, Westboro, MA, 01581, US

(21) Appl. No.: 12/075,981

(22) Filed: Mar. 14, 2008

Related U.S. Application Data
(60) Provisional application No. 60/918,547, filed on Mar. 16, 2007.

(51) Int. Cl. G11B 17/03

(52) U.S. Cl. 720/615

(57) ABSTRACT

A system and method for identifying multiple discs, prior to their use in an automated system is disclosed. A robotic arm, or similar device, is used to pick a disc from a set of unprocessed discs in a first receptacle. The robotic arm then holds the disc in position, where an imaging device captures an image of the disc. A computing system, in communication with the imaging device, determines whether a single disc is present, or multiple discs are present. Based on the result of this determination, the disc is either placed in the media reader for further processing, or rejected and placed in one of the output receptacles.

This application claims priority of U.S. Provisional Application Ser. No. 60/918,547 filed Mar. 16, 2007, the disclosure of which is incorporated herein by reference.

### BACKGROUND OF THE INVENTION

As technology moves forward, it leaves behind a wake of information in a variety of formats that may not be desired for future applications. For example, consider entertainment media. For audio material, there has been a plethora of formats, such as vinyl recordings, which existed at 33, 45 and 78 RPM, cassette recordings, and 8-Track recordings. All of these formats are nearly extinct today, replaced by digital media, such as compact disks (CDs). To date, there are almost 16 billion CDs in circulation in the United States, with over 600,000,000 new CDs added to this number each year. CDs represented 97% of all music sales in 2005, and the vast majority of music will probably remain on physical CDs for many years to come. At the same time, portable digital players, digital media centers, and digital music servers continue to proliferate at an exponential rate, while radio stations, online music stores, and internet-based music require this growing archive of music CDs to be digitized to a variety of CODECs and formats. Thus, while technology continues to move forward, it is also diverging. Previously, the single standard used by CDs served the needs of nearly every user. Today, users demand digital media in a variety in different, and often incompatible formats, for use with MP3 players, iPODs®, personal computers, DVD players, etc.

Presently, practitioners in the field use a multistage approach to converting legacy data:

Stage 1: Extraction
Extraction of raw data from original media into computable format

Stage 2: Conversion
Error correction/enhancement of raw data
Conversion of corrected raw data
Data categorization (metadata, keywords, etc)

Stage 3: Storage of final product

The second stage of this process is widely regarded as the most computational intensive. However, the first stage, extraction, has the potential to be the one requiring the most manual intervention. For example, the extraction may require the manual loading of tens, hundreds or even thousands of CDs and DVDs. While there are devices that accept many CDs at a time, these still must be loaded. The amount of manpower required to perform this function can be costly. Therefore, a more automated process is required.

The use of robotics to load the CDs can potentially be viewed as a solution to this dilemma. However, the extraction process is not trivial. For example, the discs may contain errors that make it impossible to process them. Without manual intervention, there is no way to easily determine which discs were processed correctly and which weren't. Additionally, there are numerous reasons why a disc may fail to be processed correctly. Each of these causes may require different remedial action. Without knowing which disc failed and why they failed, a robotics system may not be the panacea that it seems to be.

The second potential issue with robotics is caused by the tendency of discs to stick together. A substance between two adjacent discs may cause them to stick together. Also, static electricity can also cause two or more adjacent discs to be attracted to one another, thereby causing the same problem. Multiple discs pose a danger to an automated system, since the media reader may malfunction or become physically damaged if multiple discs are inserted simultaneously.

Therefore, a system that addresses these shortcomings would be advantageous, especially since the presentation of discs and the extraction of the data from them can be a significant contributor to cost if manual intervention is required.

### SUMMARY OF THE INVENTION

The shortcomings of the prior art have been addressed by the present invention, which describes a system and method for identifying multiple discs prior to their use in an automated system. A robotic arm, or similar device, is used to pick a disc from a set of unprocessed discs in a first receptacle. The robotic arm then holds the disc in position, where an imaging device captures an image of the disc. A computing system, in communication with the imaging device, determines whether a single disc is present, or multiple discs are present. Based on the result of this determination, the disc is either placed in the media reader for further processing, or rejected and placed in one of the output receptacles.

### BRIEF DESCRIPTION OF THE FIGURES

FIG. 1 illustrates a front view of a representative embodiment of the present invention;

FIG. 2 illustrates a representative image as received by the imaging device;

FIG. 3 illustrates the operation of the neural network in interpreting the image; and

FIG. 4 illustrates a representative flowchart showing the operation of the system.

### DETAILED DESCRIPTION OF THE INVENTION

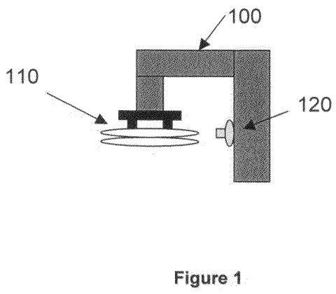

FIG. 1 illustrates a front view of the present invention. A robotic arm 100, or similar automated mechanical device, is used to select and carry a disc 110 from an input spindle to a suitable reading device, such as a CDROM reader. The input spindle contains the unprocessed discs. If desired, a number of reading devices can be used in improve the throughput of the computing system. In FIG. 1, an imaging device 120, such as a WebCam or CCD camera is conveniently located so as to view the disc 110 which has been picked up by the robotic arm 100. In FIG. 1, the imaging device 120 is shown on the robotic arm 100, however, the invention is not so limited. The imaging device 120 can be located in any position from which the disc is viewable. In operation, a computing system is in communication with the robotic arm 100 and controls its movements. The computing system directs the robotic arm to pick up a disc 110 from the input spindle. The arm is then moved to a location from which it can be viewed by the imaging device 120. The imaging device 120 records the image of the disc 110. In one embodiment, the robotic arm 100 pauses at the top of the spindle to allow for an image to be taken by the imaging device.

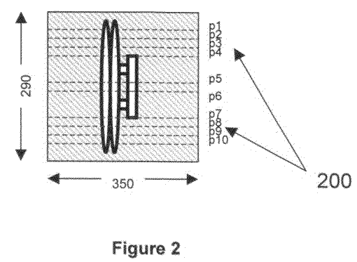

In one embodiment, the image comprises 350×290 pixels. One such image is shown in FIG. 2. This image is passed to the computing system, which executes an Image Analysis Routine. This Routine is used to process the image, and accordingly, performs a variety of functions. Two such functions include a standard edge detection and conversion from color to black and white. While these functions are the only ones listed, the Routine may also perform additional or alternative functions. The purpose of the Image Analysis Routine to be convert a color image from an imaging device into a simplified set of pixels on which further processing can be performed.

In the preferred embodiment, the Image Analysis Routine automatically selects some number of slices 200 at predefined pixels. This number should be large enough to insure proper recognition, but small enough so as not to be computationally exhaustive. In one embodiment, 5 slices are used, while in another embodiment 10 slices are used. FIG. 2 shows one set of slices 200 which can be selected. In this figure, the slices 200 are selected so as to be perpendicular to the disc 110. In this way, the plurality of slices 200 each have some information concerning the thickness of the disc stack in the image. In another embodiment, vertical slices are used. In this way, certain vertical slices are intended to show a second, attached disc if such a disc is present.

Thus, the slices can be implementation specific, and all combinations of slices are within the scope of the invention. Preferably, the slices are selected based on the position of the disc(s) 110 in the image field during an initial calibration snapshot.

These slices 200, or feature vectors, which represent a subset of the total number of pixels, are then further processed. In the preferred embodiment, these “feature vectors” are passed to an Artificial Neural Network (ANN) that has been trained to identify multiple discs in the image field. The training procedure is described in more detail below.

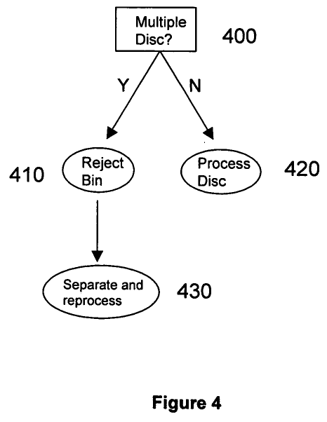

Based on its earlier training, the Artificial Neural Network is able to classify the image as one in which there is one or multiple discs. FIG. 4 shows a representative flowchart of the present invention. The ANN examines the image to make a determination, as shown in Box 400. If the image is classified as multiple pickup, the robotic arm is automatically instructed to place the discs in a ‘reject’ bin or spindle, as shown in Box 410. If the image is classified as a single disc pickup, the disc is placed in the waiting media reader and allowed to continue through to audio extraction, as shown in Box 420.

At a later time, such as after processing is complete, the ‘reject’ bin, receptacle or spindle can be manually inspected. Discs that are stuck together can be manually separated and wiped with a cloth to remove any remaining residue, as shown in Box 430. Single discs that were incorrectly identified are placed on the input spindle for reprocessing, along with the newly separated discs.

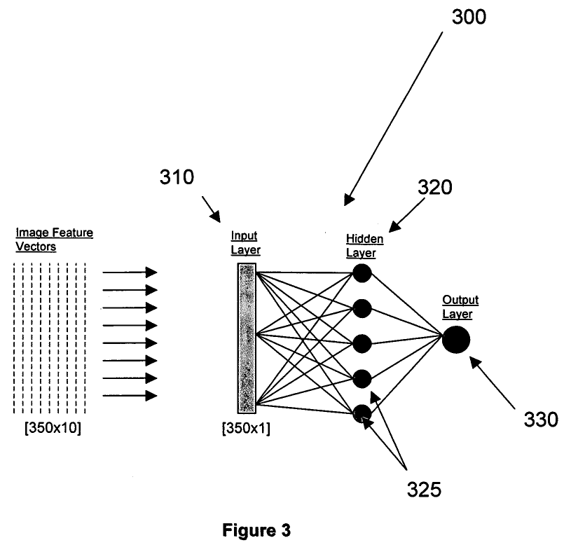

Having described the overall operation of the system, it is necessary to describe the neural network's creation, training and testing. In the preferred embodiment, shown in FIG. 3, a standard backpropagation network 300 was created using 3 layers (the input layer 310, the hidden layer 320 and the output layer 330) and 5 hidden units 325, although other numbers of layers and hidden units are possible. The network allows for a large number of inputs and yields a single output: 0 for the case of a single disc pickup and 1 for the case of a multiple disc pickup. In this embodiment, double or triple pickups are treated the same, since the resulting action is the same.

The network allows for a sufficient number of inputs. For example, in FIG. 2, a total of 10 feature vectors were used, where each of the ten vectors contains 35 pixels. Thus, in this embodiment, the neural network must accept 350 inputs. This value obviously varies with the number of feature vectors used and the resolution of the original image.

In one embodiment, the Artificial Neural Network is trained using 100 images of a single disc pickup, 100 images of a double disc pickup and 100 images of a triple disc pickup. The images were presented to the network one by one (or more accurately, 10 feature vectors at a time).

After training, the network was tested with 50 snapshots using: 50% single disc, 25% double disc, and 25% triple disc pickups. The false positive rate (FPR) was 0% and the false negative rate (FNR) was 5%. In other words, the network identified a single disc lift as a multiple disc lift 5% of the time. The network was purposely designed to err in this way. The only disadvantage of a false negative is increased processing time. However, a false positive would result in the placement of multiple discs in the media reader, thereby risking physical damage.

In one embodiment, after the network has been trained and optimized, it takes a total of approximately 2 seconds to snapshot and classify the image. This process adds some overhead, and thus slows overall system throughput. However, the reduction in throughput is more than offset by the avoidance of potential damage of discs and equipment from multiple disc insertions. Furthermore, the time required to recover from a multiple disc insertion also greatly exceeds the time used for the above described processing.

The software described above can be written in a variety of languages, using a variety of tools. One of ordinary skill in the art would understand the proper tools to use to develop such a system. In one embodiment, the routine is written in MATLAB language. In another embodiment, the routine is ported as a standalone application for Linux.

While the above description pertains to discs, such as compact discs and DVDs, the invention is not so limited. The same system and method can be used to differentiate between other items as well.

Similarly, although the disclosure describes differentiating between one and multiple discs, the invention is not so limited. Once properly trained, the neural network can be used to differentiate items using any visible characteristic, such as size, thickness, shape, etc.

The above invention can also by used in connection with an automated extraction system. Such systems are described in co-pending applications, “Automated Audio Extraction System” and “High Throughput System for Legacy Media Conversion”, the disclosures of which are hereby incorporated by reference.

What is claimed is:

1. A system for determining a characteristic of an item held by a robotic arm, comprising:
a. Said robotic arm, adapted to pick up said item;
b. An imaging device, adapted to capture an image of said item subsequent to said pick up; and
c. A computing system, comprising instructions adapted to process said image and determine said characteristic of said item based on said processed image.

2. The system of claim 1, wherein said instructions comprise a neural network.

3. The system of claim 1, wherein said item comprises a disc and said characteristic comprises the quantity of said discs picked up by said robotic arm.

4. The system of claim 3, further comprising a media reader, wherein said computing system instructs said robotic arm to place said disc in said media reader if it is determined that said item comprises exactly one disc.

5. The system of claim 3, wherein said computing system instructs said robotic arm to place said item in a predetermined location if it is determined that said item comprises more than one disc.

6. A method of determining a characteristic of an item held by a robotic arm, comprising:
a. Picking up said item using said robotic arm;
b. Placing said item in the view of an imaging device;
c. Using said imaging device to capture an image of said item subsequent to said pick up;
d. Processing said image; and
e. determining said characteristic of said item based on said processed image.

7. The method of claim 6, whereby said item comprises a disc and said characteristic comprises the number of discs picked up by said robotic arm.

8. The method of claim 7, further comprising placing said disc into a media reader if it is determined that said item comprises exactly one disc.

9. The method of claim 7, further comprising placing said item in a predetermined location if it is determined that said item comprises more than one disc.
